(19) United States
(12) Patent Application Publication
(10) Pub. No.: US 2023/0104216 A1
(43) Pub. Date: Apr. 6, 2023

(54) WIRELESS CHARGE COIL

(71) Applicant: HAESUNG DS CO., LTD., Gyeongsangnam-do (KR)

(72) Inventors: Sang Hak LEE, Gyeonggi-do (KR); Ki Min LEE, Seoul (KR); Dong Hyuk LEE, Seoul (KR)

(21) Appl. No.: 17/930,910

(22) Filed: Sep. 9, 2022

(30) Foreign Application Priority Data
Oct. 6, 2021 (KR) 10-2021-0132714
Mar. 28, 2022 (KR) 10-2022-0038323

(51) Int. Cl. H01F 27/34; H02J 50/10; H01F 38/14; H01F 27/28

(52) U.S. Cl. CPC H01F 27/34; H01F 27/2823; H01F 27/2885; H01F 38/14; H02J 50/10

(57) ABSTRACT

According to one or more embodiments, a wireless charge coil for wireless charging of a portable terminal includes an installation member, and a conducting wire portion arranged at the installation member, wherein the conducting wire portion comprises a conductor and a shielding layer arranged on at least one surface of the conductor, and wherein the shielding layer includes a plurality of magnetic layers and at least one non-magnetic layer.

### CROSS-REFERENCE TO RELATED APPLICATIONS

This application is based on and claims priority under 35 U.S.C. §119 to Korean Patent Application Nos. 10-2021-0132714, filed on Oct. 6, 2021 and 10-2022-0038323 filed on Mar. 28, 2022 in the Korean Intellectual Property Office, the disclosures of which are incorporated by reference herein in their entirety.

### BACKGROUND

### 1. Field

One or more embodiments relates to a wireless charge coil.

### 2. Description of the Related Art

Recently, charging systems using a method of transmitting power wirelessly have been actively developed. In particular, a wireless charging system is commonly embedded in portable terminals such as a mobile phone, a notebook, etc.

Among design factors of a wireless charge coil, a quality factor is a key factor related to wireless charging efficiency. The higher the quality factor is, the higher the wireless charging efficiency may be. Accordingly, many efforts have been made to increase the quality factor.

As shown in the following Equation 1, as a quality factor Q is proportional to an inductance L and inversely proportional to an AC(alternating current) resistance R_{AC}, increasing the quality factor Q by reducing the AC resistance R_{AC} may be considered.

[Equation 1 ]

$$Q = \frac{2 π f L}{{R}_{A C}}$$

, here, f represents a usable frequency, L represents a coil inductance, and R_{AC} represents an AC resistance.

The AC resistance R_{AC} of a wireless charge receiver antenna may be represented as the following [Equation 2].

[Equation 2]

$${R}_{A C} = {R}_{D C} \left[1 + {Y}_{S +} {Y}_{P}\right]$$

, here, R_{DC} represents a DC(direct current) resistance, Ys represents a resistance component due to skin effects, and Yp represents a resistance component due to proximity effects.

Accordingly, to increase the quality factor Q by reducing the AC resistance R_{AC}, the DC resistance R_{DC}, the skin effect resistance component Ys, and the proximity effect resistance component Yp need to be reduced.

Here, the skin effect refers to the effect that in a coil in which an alternating current flows, the alternating current does not flow evenly on a cross-section of the coil, i.e., little or no alternating current flows at the center portion of the coil while a large amount of alternating current flows at the periphery of the coil. As illustrated in FIG. 1A, when an alternating current flows in a coil 1, as a current density J does not exist at the center portion of the coil 1 but is distributed at the periphery of the coil 1, the alternating current may not flow at the center portion of the coil 1 but only flow at the periphery of the coil 1.

The proximity effect may refer to the effect that when an alternating current flows in adjacent coils, a current density of the alternating current flowing in the coils is concentrated at one side. Such proximity effect may become severe when a frequency is high and a distance between the adjacent coils is smaller. As illustrated in FIG. 1B, when an alternating current flows in adjacent coils 3 and 5, the current density J of each of the coils 3 and 5 may be distributed to areas of the coils 3 and 5 away from each other but not distributed to areas of the coils 3 and 5 adjacent to each other. As such, when the alternating current flows in the adjacent coils 3 and 5, each of the coils 3 and 5 may be affected by not only the skin effect but also the proximity effect.

Korean Laid-Open Publication No. 10-2020-0104589 discloses a wireless charge coil with a winding portion including a divided area, the wireless charge coil having improved charging efficiency by reducing a resistance component due to the skin effect and the proximity effect.

### SUMMARY

One or more embodiments include a wireless charge coil with improved quality factor value.

Additional aspects will be set forth in part in the description which follows and, in part, will be apparent from the description, or may be learned by practice of the presented embodiments of the disclosure.

According to one or more embodiments, a wireless charge coil for wireless charging of a portable terminal includes an installation member, and a conducting wire portion arranged at the installation member, wherein the conducting wire portion comprises a conductor and a shielding layer arranged on at least one surface of the conductor, and wherein the shielding layer includes a plurality of magnetic layers and at least one non-magnetic layer.

The conductor may include a lead frame material.

The magnetic material layer may be a permalloy plating layer.

The shielding layer may have a structure in which the magnetic layer and the non-magnetic layer is alternately stacked.

At least one of the plurality of magnetic layers may have a different permeability.

Among the plurality of magnetic layers, a magnetic layer having a lower permeability may be arranged closer to the conductor.

One surface of the conductor may be in contact with the installation member, and the shielding layer may be arranged on a remaining surface of the conductor, excluding the surface which is in contact with the installation member.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating the skin effect;

FIG. 1B is a diagram illustrating the proximity effect in adjacent coils;

FIG. 2 is a schematic plan view illustrating a wireless charge coil according to an embodiment;

FIG. 3 is a cross-sectional view of a conducting wire portion of a wireless charge coil according to an embodiment;

FIG. 4 is a partial cross-sectional view of a conducting wire portion of a wireless charge coil according to a modification example of an embodiment;

FIG. 5 is a partial cross-sectional view of a conducting wire portion of a wireless charge coil according to another modification example of an embodiment;

FIGS. 6A to 6D are schematic diagrams illustrating a process of manufacturing a wireless charge coil according to an embodiment; and

FIG. 7 is a schematic view illustrating power transmission to a wireless charge coil according to an embodiment.

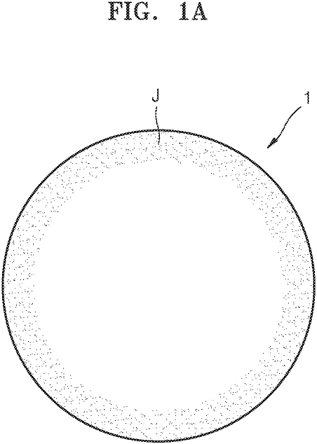

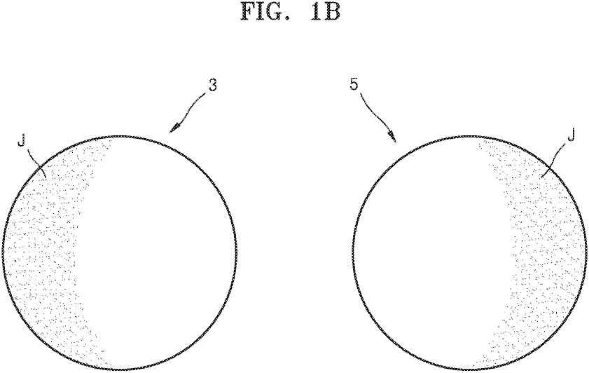

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the disclosure according to embodiments is described in detail with reference to the accompanying drawings. In the specification and drawings, like reference numeral denote like components to omit redundant description, and sizes, ratios of length, etc. may be exaggerated to facilitate the understanding.

The disclosure may be clarified by referring to the following embodiments along with the accompanying drawings. However, the disclosure is not limited by the following embodiments and may be implemented in various forma. Rather, the embodiments are provided so that this disclosure will be thorough and complete, and will fully convey the scope of embodiments to one of ordinary skill in the art. The disclosure is defined by the scope of claims.

The terms used herein are merely used to describe the embodiments and are not intended to limit the disclosure. An expression used in the singular encompasses the expression of the plural, unless it has a clearly different meaning in the context. In the specification, it is to be understood that the terms such as ”comprises and/or “comprising” are not intended to exclude the possibility that one or more other components, steps, operations and/or elements may exist or may be added in addition to the mentioned components, steps, operations and/or elements. While such terms as “first,” “second,” “upper surface,” “lower surface,” etc., may be used to describe various components, such components must not be limited to the above terms. The above terms are used only to distinguish one component from another.

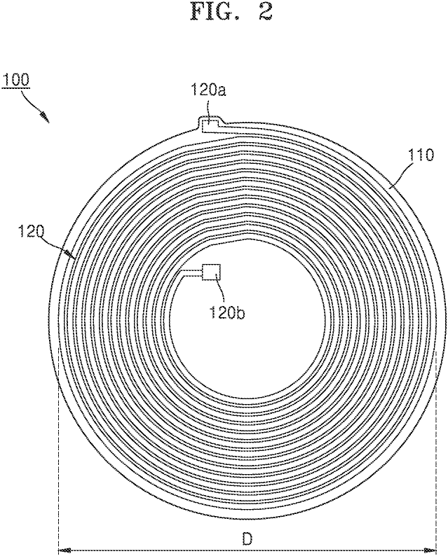

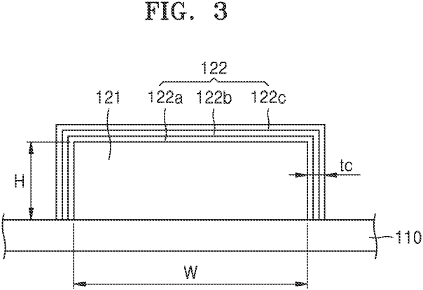

FIG. 2 is a schematic plan view illustrating a wireless charge coil according to an embodiment, and FIG. 3 is a cross-sectional view of a conducting wire portion of a wireless charge coil according to an embodiment.

As illustrated in FIG. 2, a wireless charge coil 100 according to an embodiment may include an installation member 110 having a shape of a film, and a conducting wire portion 120 arranged in the installation member 110 and having a shape of a circular pattern. Terminals 120a and 120b are arranged at the ends of the conducting wire portion 120.

The installation member 110 may be an insulating substrate used when forming a shielding layer 122 and may include various materials, such as polyimide, polyurethane, etc.

The installation member 110 according to the embodiment may be an insulating substrate used when forming the shielding layer 122; however, the disclosure is not limited thereto. That is, according to the disclosure, when a process of forming the shielding layer 122 is completed, a substrate used for formation of the shielding layer 122 may be replaced, and a new substrate may be arranged in the wireless charge coil 100 as an installation member.

As illustrated in FIG. 3, the conducting wire portion 120 according to the disclosure may include a conductor 121 and the shielding layer 122 surrounding an upper surface and lateral surfaces of the conductor 121. That is, the conductor 121 may be in contact with the installation member 110, and the shielding layer 122 may be arranged on a remaining surface excluding the surface in contact with the installation member 110.

According to the embodiment, the shielding layer 122 may be arranged to surround the upper surface and lateral surfaces of the conductor 121; however, the disclosure is not limited thereto. That is, the shielding layer 122 according to the disclosure may surround at least one surface of the conductor 121. For example, the shielding layer 122 according to the disclosure may be arranged only on the lateral surfaces of the conductor 121.

The conductor 121 according to the embodiment may be manufactured in the shape of the circular pattern by transferring a conductive thin film through the roll-to-roll process and processing the conductive thin film through etching or punching. The conductive thin film may include various conductive materials, such as copper, alloys containing copper, gold, silver, etc., and may be in the form of rolled foil or electrolytic foil. For example, the conductor 121 may include a raw material of a lead frame.

The conductor 121 according to an embodiment may be manufactured in the shape of a circular pattern; however, the disclosure is not limited thereto. That is, no specific limitation is posed on the shape of the conductor 121 according to the disclosure. For example, as long as the conductor 121 according to the disclosure has a certain inductance allowing wireless charging, no particular limitation is posed on the shape of the conductor 121. For example, the conductor 121 according to the disclosure may have various shapes, such as a tetragonal pattern, zigzag pattern, etc.

Moreover, the conductor 121 according to the embodiment may be transferred and manufactured through the roll-to-roll process; however, the disclosure is not limited thereto. That is, the manufacturing of the conductor 121 according to the disclosure may not use the roll-to-roll process and the conductor 121 of the wireless charge coil may be manufactured by processing the conductive thin material into a conductive plate.

The thickness H of the conductor 121 according to the embodiment may be about 50 µm to about 300 µm.

The width W of the conductor 121 according to the embodiment may be determined according to a size of external diameter D of the wireless charge coil 100 and performance requirement of the inductance and in consideration of total winding number.

By the shielding effect, the shielding layer 122 may reduce a resistance component Yp caused by the proximity effect between the adjacent conductors 121. Then, by reducing the AC resistance R_{AC}, the quality factor Q value may be improved (see Equations 1 and 2). That is, as the shielding layer 122 has high permeability, the quality factor Q value may be increased by reducing the electromagnetic interference effect between the neighboring conductors 121.

A total thickness tc of the shielding layer 122 may be determined by considering the specification and quality factor Q of the wireless charge coil 100. As the total thickness tc of the shielding layer 122 is a constraint condition according to the specification, it is important to implement the shielding layer 122 having an excellent shielding performance while the thickness thereof does not exceed a limited thickness. That is, as for a wireless charge coil used in a portable terminal for wireless charging, the whole size thereof (diameter and thickness) is limited by overall specifications such as size, performance, etc. of commercial products, and the specification regarding the thickness, width, and winding number of the conductor 121 of the wireless charge coil 100 is determined accordingly. Hence, a limit on the total thickness tc of the shielding layer 122 applied to the conductor 121 may be determined according to such specification. For example, an exemplary specification of a wireless charge coil for portable terminal suggested by the Wireless Power Consortium (WPC) is: a total external diameter less than or equal to about 50 mm; an internal diameter greater than or equal to about 25 mm, and a winding number of about 10.

Hereinafter, the structure of the shielding layer 122 is described in detail.

The shielding layer according to the disclosure may include a plurality of magnetic layers and at least one non-magnetic layer, and the shielding layer 122 according to the embodiment may include a first magnetic layer 122a, a first non-magnetic layer 122b, and a second magnetic layer 122c as illustrated in FIG. 3.

The first magnetic layer 122a and the second magnetic layer 122c may be permalloy plating layers including nickel, iron, etc. The nickel content in the permalloy plating layer may be 70 % to 80 % of the total so that the shielding layer 122 has the characteristic of high permeability. The permeability of the permalloy plating layer may be greater than or equal to 5000, and to achieve such permeability, selecting the composition, particle size, etc. of nickel may be important.

When the frequency of 100 kHz is applied, the permeability according to the permalloy composition ratio may be as shown in the following Table 1.

TABLE 1

| Permalloy composition | Permeability (µ) value |
|---|---|
| Ni 79%, Fe 17%, Mo 4% | 20000 |
| Ni 78%, Fe 22% | 8000 |
| Ni 80%, Fe 20% | 5000 |

According to the embodiment, the permalloy plating layers having the same composition may be applied as the first magnetic layer 122a and the second magnetic layer 122c.

According to the embodiment, the permalloy plating layers having the same composition and therefore the same permeability may be applied as the first magnetic layer 122a and the second magnetic layer 122c; however, the disclosure is not limited thereto. That is, according to the disclosure, at least one of the plurality of magnetic layers may have a different permeability.

Furthermore, according to the embodiment, the first magnetic layer 122a and the second magnetic layer 122c may include a permalloy plating layer containing nickel, iron, etc.; however, the disclosure is not limited thereto. That is, the magnetic layer according to the disclosure may be applied regardless of its material as long as it has the effect of electromagnetic shield. For example, the magnetic layer may include FeSiBCr, CoF-based soft magnetic alloy, Fe-based soft magnetic alloy, Co-based soft magnetic alloy, NiFe-based soft magnetic alloy, Ba-based ferrite, MnZn-based ferrite, NiZn-based ferrite, and NiZnCu-based ferrite.

The first magnetic layer 122a and the second magnetic layer 122c may be arranged by using various methods, such as a plating method, screen printing, etc. When the plating method is applied, electroplating, electroless plating, etc. may be used.

The first non-magnetic layer 122b may include a non-magnetic material. The non-magnetic material is a concept encompassing a diamagnet and a paramagnet. General diamagnetic materials, such as copper, gold, silver, etc. may be applied as a diamagnet, and general paramagnetic materials, such as aluminum, platinum, etc. may be applied as a paramagnet.

The first non-magnetic layer 122b may be arranged by using various methods, such as a plating method, screen printing, etc. When the plating method is applied, electroplating, electroless plating, etc. may be used.

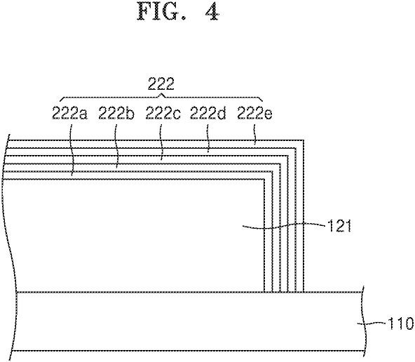

The shielding layer 122 according to the embodiment illustrated in FIG. 3 may include three layers, i.e., the first magnetic layer 122a, the first non-magnetic layer 122b, and the second magnetic layer 122c, and the magnetic layers constituting the first magnetic layer 122a and the second magnetic layer 122c may have the same permeability. However, the disclosure is not limited thereto. According to the disclosure, the shielding layer 122 may include a plurality of magnetic layers, and no particular limitation is posed on the number of the magnetic layers and the number of non-magnetic layers included in the shielding layer 122. For example, a shielding layer 222 may include a first magnetic layer 222a, a first non-magnetic layer 222b, a second magnetic layer 222c, a second non-magnetic layer 222d, and a third magnetic layer 222e as illustrated in FIG. 4. The first magnetic layer 222a, the second magnetic layer 222c, and the third magnetic layer 222e may have different permeabilities. The first magnetic layer 222a may include a permalloy plating layer having a composition of 80 % of nickel and 20 % of iron, the second magnetic layer 222c may include a permalloy plating layer having a composition of 78 % of nickel and 22 % of iron, and the third magnetic layer 222e may include a permalloy plating layer having a composition of 79 % of nickel, 17 % of iron, and 4 % of molybdenum. As shown in Table 1, as the permeability (µ) increases in order of the first magnetic layer 222a, the second magnetic layer 222c, and the third magnetic layer 222e, a magnetic layer having a lower permeability among the first to third magnetic layers 222a, 222c, and 222e may be arranged closer to the conductor 121. As such stacked structure has a permeability that increases from the center towards the outer surface, the shielding effect may be enhanced. The first non-magnetic layer 222b and the second non-magnetic layer 222d may include the same or different non-magnetic material.

The first magnetic layer 222a, the second magnetic layer 222c, and the third magnetic layer 222e of the shielding layer 222 illustrated in FIG. 4 may have different permeabilities by varying the composition of the permalloy plating layer; however, the disclosure is not limited thereto. That is, according to the disclosure, by applying completely different materials to each of the first magnetic layer 222a, the second magnetic layer 222c, and the third magnetic layer 222e, the first magnetic layer 222a, the second magnetic layer 222c, and the third magnetic layer 222e may have different permeabilities.

Furthermore, a magnetic layer having a lower permeability among the first magnetic layer 222a, the second magnetic layer 222c, and the third magnetic layer 222e of the shielding layer 222 illustrated in FIG. 4 may be arranged closer to the conductor 121; however, the disclosure is not limited thereto. According to the disclosure, a magnetic layer having a lower permeability among the plurality of magnetic layers may be arranged further from the conductor 121.

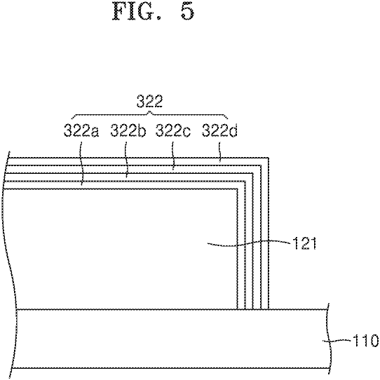

The shielding layer 122 according to the embodiment illustrated in FIG. 3 may include three layers, i.e., the first magnetic layer 122a, the first non-magnetic layer 122b, and the second magnetic layer 122c, and by arranging the first non-magnetic layer 122b between the first magnetic layer 122a and the second magnetic layer 122c, the shielding layer 122 may have a structure in which the magnetic layers, i.e., the first magnetic layer 122a and the second magnetic layer 122c, and the non-magnetic layers, i.e., the first non-magnetic layer 122b are stacked alternately; however, the disclosure is not limited thereto. That is, according to the disclosure, the shielding layer 122 may not have a structure in which a magnetic layer and a non-magnetic layer are alternately stacked. For example, as illustrated in FIG. 5, a shielding layer 322 may include a first magnetic layer 322a, a second magnetic layer 322b, a first non-magnetic layer 322c, and a third magnetic layer 322d. The second magnetic layer 322b may arranged directly on the first magnetic layer 322a. The first magnetic layer 222a, the second magnetic layer 222c, and the third magnetic layer 222e may have the same or different permeability.

According to the structure of the shielding layer 122 of the wireless charge coil 100 of the embodiment, the shielding layer 122 may include the first magnetic layer 122a, the first non-magnetic layer 122b, and the second magnetic layer 122c, and the first magnetic layer 122a, the first non-magnetic layer 122b, and the second magnetic layer 122c may be formed by the plating method. The structure of the shielding layer 122 according to the embodiment may not need to form a single magnetic material plating layer having a great thickness to improve the electromagnetic shielding effect. That is, in general, the thicker a thickness of a magnetic material plating layer is, the greater the shielding effect may be; however, not only a thick single magnetic material plating layer is hard to form but also it costs much to form one. Unlike the above, in the embodiment, as a plurality of magnetic layers having a small thickness and at least one non-magnetic layer are stacked to constitute a shielding layer and implement the electromagnetic shielding function, not only more improved shielding effect may be achieved through the magnetic flux overlapping effect, but also the manufacturing expense may be reduced and the manufacturing easiness may be improved due to the overlapping of thin plating layers having a small thickness.

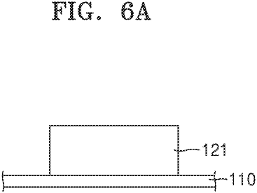

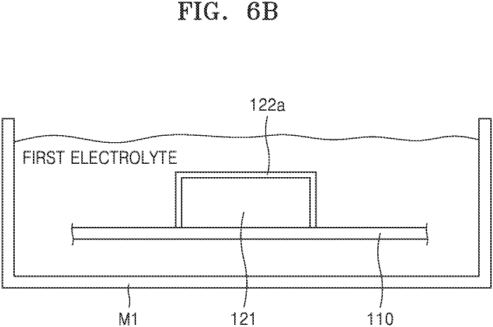

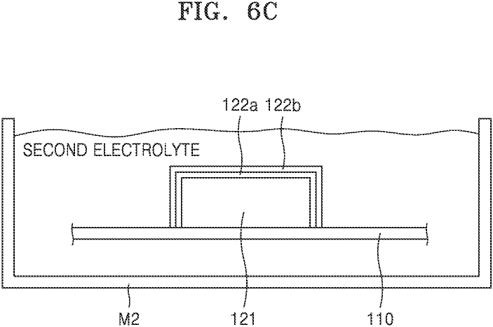

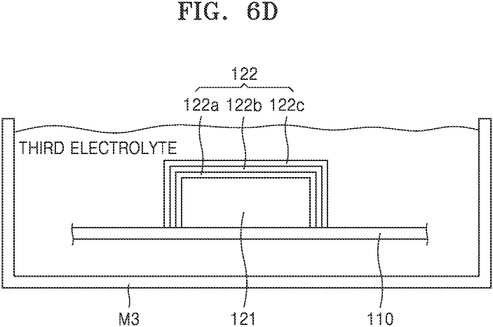

Hereinafter, the manufacturing method of the wireless charge coil 100 according to the embodiment are described with reference to FIGS. 6A to 6D.

First, as illustrated in FIG. 6A, the conductor 121 having a shape of the circular pattern may be arranged on the installation member 110 having a shape of a film.

The conductor 121 may be formed in the shape of circular pattern by processing the conductive thin material through etching, punching, etc. and attached to the installation member 110. At this time, and adhesive material may be provided between the conductor 121 and the installation member 110 to facilitate the attachment.

As illustrated in FIG. 6B, the permalloy electroplating may be performed by immersing the conductor 121 and the installation member 110 into an electrolytic bath M1 filled with a first electrolyte including a permalloy material to form the first magnetic layer 122a on the upper surface and lateral surfaces of the conductor 121.

Then, as illustrated in FIG. 6C, the electroplating may be performed by immersing the conductor 121 and the installation member 110 into an electrolytic bath M2 filled with a second electrolyte including copper. As the first magnetic layer 122a is formed on the conductor 121, the first non-magnetic layer 122b including copper may be arranged on the first magnetic layer 122a by the electroplating.

Afterwards, as illustrated in FIG. 6D, the permalloy electroplating may be performed by immersing the conductor 121 and the installation member 110 into an electrolytic bath M3 filled with a third electrolyte including a permalloy material. As the first magnetic layer 122a and the first non-magnetic layer 122b are formed on the conductor 121, the second magnetic layer 122c may be arranged on the first non-magnetic layer 122b by the permalloy electroplating, thereby completing the shielding layer 122.

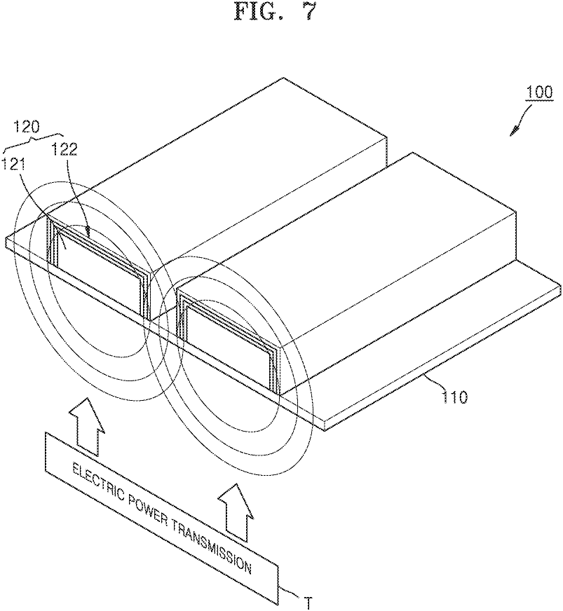

Hereinafter, the aspect of transmitting power to the wireless charge coil 100 is described with reference to FIG. 7.

As illustrated in FIG. 7, the wireless charge coil 100 of the embodiment may be used as receiver coil, and in this case, a transmitter T may be arranged to face the installation member 110.

When the transmitter T is driven, due to the electromagnetic field generated from the transmitter T, a current may be induced to the wireless charge coil 100 and charging may be performed. At this time, as the wireless charge coil 100 includes the shielding layer 122 of proper thickness, the skin effect and the proximity effect may be reduced. In such case, not only the quality factor regarding the wireless charging efficiency increases, but also the function of preventing heat generation of the wireless charge coil 100 may be improved.

The wireless charge coil 100 according to the embodiment may be used a receiver coil; however, the disclosure is not limited thereto. That is, the wireless charge coil 100 may be used limitlessly as a transmitting coil, or a receiver coil.

Although the electric power transmission and reception using the wireless charge coil 100 according to the embodiment is performed by an electromagnetic induction method, the disclosure is not limited thereto. That is, the electric power transmission and reception of the wireless charge coil 100 according to the disclosure may be applied to an electromagnetic resonance method and radio frequency (RF) wireless electric power transmission method.

As the wireless charge coil 100 according to an aspect of the disclosure includes the conducting wire portion including the shielding layer 122, the wireless charge coil 100 may have an effect of increasing the quality factor value.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

### Industrial Applicability

The disclosure may be used in a wireless charge coil manufacturing industry, etc.

What is claimed is:

1. A wireless charge coil for wireless charging of a portable terminal, the wireless charge coil comprising:
an installation member; and
a conducting wire portion arranged at the installation member,
wherein the conducting wire portion comprises a conductor and a shielding layer arranged on at least one surface of the conductor, and
the shielding layer comprises a plurality of magnetic layers and at least one non-magnetic layer.

2. The wireless charge coil of claim 1, wherein the conductor includes a lead frame material.

3. The wireless charge coil of claim 1, wherein the magnetic layer is a permalloy plating layer.

4. The wireless charge coil of claim 1, wherein the shielding layer has a structure in which the magnetic layer and the non-magnetic layer are alternately stacked.

5. The wireless charge coil of claim 1, wherein at least one of the plurality of magnetic layers has a different permeability.

6. The wireless charge coil of claim 5, wherein, among the plurality of magnetic layers, a magnetic layer having a lower permeability is arranged closer to the conductor.

7. The wireless charge coil of claim 1, wherein one surface of the conductor is in contact with the installation member, and
the shielding layer is arranged on a remaining surface of the conductor, excluding the surface which is in contact with the installation member.
